(19) United States
(12) Patent Application Publication
(10) Pub. No.: US 2006/0280208 A1
(43) Pub. Date: Dec. 14, 2006

(54) Fiber laser

(76) Inventors: Valery Baev, Hamburg (DE); Stefan Salewski, Stade (DE); Arnold Stark, Hamburg (DE); Peter E. Toschek, Hamburg (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/542,713

(22) PCT Filed: Jan. 21, 2004
(86) PCT No.: PCT/EP04/00443

§ 371 Date: Mar. 31, 2006

(30) Foreign Application Priority Data
Jan. 21, 2003 (DE) 103 02 031.4

(51) Int. Cl. H01S 3/30; H01S 3/10; H01S 3/08

(52) U.S. Cl. 372/6; 372/20; 372/99

(57) ABSTRACT

A diode laser pumped, power stabilized fiber laser comprising a doted fiber, a pumping light source, as well as entrance and exit side resonator units wherein the entrance resonator unit and/or the exit resonator unit have controllable distances (gaps) to the fiber end faces, which are up to 20 μm wide. A controllable variation of the gap widths allows for the generation of light emission on a plurality of switchable and simultaneously excited emission wavelengths in the visible and the near infrared ranges.

The invention refers to a fiber laser with simultaneous or switchable light emission in a plurality of spectral ranges.

In a fiber laser, the laser-active medium is included in a light guide. The laser activity of the fiber is obtained in particular by doping the fiber core with rare earth ions. For many laser transitions of rare earth ions, laser emission was first observed in fiber lasers, especially since fluoride glass, mainly fluorozirconate glass ZBLAN, is used as a host besides silicate glass.

The ions are excited by a pumped light source for generating pumped light to be coupled into the fiber. The pumped light is irradiated longitudinally into the fiber, so that it is absorbed by the ions. The pumped light is focused onto the end face of the fiber using a lens, is coupled into the fiber core and guided therein.

Such a fiber laser is known from DE 196 36 236 A1, for example. The multimodal waveguide laser described therein comprises a diode laser as the pumping laser. Using a collimation optic, the light emitted by the diode laser is coupled into the fiber at the entrance side thereof. A mirror is provided on the entrance side of the fiber. The mirror is only very poorly reflecting the pumped wavelength generated by the diode laser. However, the light generated in the fiber is reflected well by the mirror at the entrance side. The opposite fiber end, the exit end of the fiber, reflects the generated light only very weakly. To effectively couple light generated in the fiber back into the fiber, a mirror is arranged at a distance from the exit side of the fiber. The light reflected by this resonator mirror is focused and coupled back into the fiber by a lens arranged between the exit side of the fiber and the resonator mirror.

Many practical applications such as confocal microscopy, optical data storage and laser displays, for example, require efficient, reliable, compact and economic coherent light sources emitting on emission wavelengths in the visible range. Suited light sources for this purpose are diode laser pumped up-conversion fiber lasers. Such a fiber laser is known from U.S. Pat. No. 5,727,007. This fiber laser is disadvantageous in that it can emit only in a selected spectral range and requires two different laser diodes as pumping sources.

A suitable light source for the above mentioned applications is known from WO 01/99243 A1. The fiber laser described there requires but a single pumping laser diode and emits on a plurality of emission wavelengths in the visible and the near infrared ranges, either switchable or simultaneously. The resonator of this laser is a doped fiber, an input coupler (entrance resonator unit) provided at the entrance side of the fiber, and an exit resonator unit connected with the exit side of the fiber. The exit resonator unit comprises a second resonator mirror connected with the exit side of the fiber, and a third resonator mirror arranged at a distance from the exit side. The first and the second resonator mirror are highly reflective in the wavelength range with the least light amplification and thus allow for a preferred excitation of weak emission lines. With a ZBLAN fiber doted with praseodymium and ytterbium, for example, laser emission is excited at 491 nm. The third resonator mirror serves for a controlled increase of the feedback in one of the other transitions, e.g. in the wavelength range of 635 nm. This results in laser light being generated and controlled simultaneously or individually in at least two wavelength ranges. With the fiber laser described in WO 01/99243 A1, the first or entrance resonator unit is designed as a wavelength-selective mirror, transparent for the wavelength of the pumping light source and reflective for the remaining wavelengths. The mirror of the entrance resonance unit is provided directly at the entrance side of the fiber.

Alternatively, the third resonator mirror remains unmodified and the modification of the feedback is effected by the modification of an adjustable air gap between the exit side of the fiber and the second resonator mirror. The increase in the feedback at the exit side of the fiber most often causes a larger increase in backward directed light emission, i.e. from the entrance side of the fiber, and therefore reduces the efficiency of the laser.

It is an object of the present invention to provide a fiber laser which emits light of two, in particular three or more colors simultaneously or individually with particular efficiency.

The object is solved according to the invention with the features of claim 1.

The present fiber laser comprises a fiber for generating light. The fiber has an entrance side and an exit side, wherein pumped light, preferably generated by a diode laser, is coupled into the fiber through the entrance side in particular with the aid of a collimation unit. According to the invention, the entrance resonator unit comprises at least one dielectric layer or a dielectric region whose optical thickness for determining the at least one emission range is variable. Due to the variability of the optical thickness of this dielectric layer it is possible to vary the emission range of the present fiber laser.

The optical thickness of the dielectric layer or the dielectric region may be varied, for example, by including a, e.g., gaseous medium in the layer and varying the pressure. The variation of the pressure changes the optical thickness of the layer. In this preferred embodiment, the dielectric region is thus preferably designed as a chamber in which a gaseous medium is present. The chamber is connected with a pressure control means by which, for example by supplying or discharging gas, the pressure in the chamber can be varied. It is also possible, instead of or in addition to controlling the pressure in the chamber, to vary the kind of gas or gas mixtures introduced, so as to change the optical thickness. Thus, the composition of the medium can be changed or, possibly, exchanged completely in order to change the optical thickness of the layer or the dielectric region.

The corresponding dielectric layer may also be provided in an electric field. A variation of the field strength changes the optical thickness of the layer. A corresponding field strength control means is provided for varying the field strength.

It is particularly preferred to provide an optical reflecting element, such as a mirror, so that the dielectric layer, whose optical thickness is to be varied, is arranged between the optical reflecting element and the entrance side of the fiber. Here, the optical thickness may be effected by shifting the optical reflecting element. Of course, the different methods for changing the optical thickness of the dielectric layer may also be combined. Possibly, further dielectric layers with a fixed or variable optical thickness may be provided. Preferably, the optical reflecting element is shifted at least partly in the longitudinal direction of the fiber.

In a particularly preferred embodiment, the invention provides that the reflecting element (preferably wavelength-selective dielectric mirrors) of the entrance resonator unit arranged at the entrance side is disposed at a distance from the entrance side. Thereby, a gap is obtained that, in particular, is part of a multi-layered dielectric mirror system. Preferably, the width of the gap is selected not much larger than the wavelength of the laser emission. Since the distance between the reflecting element of the resonator entrance unit and the entrance side of the fiber is preferably variable according to the invention, the optical thickness of the layer or the width of the gap can be changed. This results in a change of the reflectance spectrum of the mirror system. By changing the reflectance spectrum, the wavelength or a wavelength range can be set in which the entrance resonator unit is highly reflective or weakly reflective, respectively. As a result, the light emission will switch from one color to another when the gap is changed. An increase in the reflectance of the mirror on the entrance side of the fiber means an increase in efficiency, since the light flux now increases in the out-coupling direction. It may also happen that some other colors can be excited upon a change of the gap width. In the range of a change of color, it is also possible to simultaneously generate two or more colors and to adjust the ratio of the light powers in these wavelength ranges.

Instead of an entrance resonator unit configured according to the invention, a correspondingly designed exit resonator unit may also be provided. The exit resonator unit of the invention thus also comprises at least one dielectric layer with a variable optical thickness. Varying the optical thickness of this layer may be effected as described above for the entrance resonator unit. It is particularly preferred to provide both an entrance resonator unit according to the invention and an exit resonator unit according to the invention. This allows to generate preferably a plurality of spectral emissions with the aid of a simple resonator configuration.

It is particularly preferred to configure the reflecting element of the exit resonator unit, which preferably is a wavelength-selective dielectric mirror, such that it is arranged at a distance from the exit side of the fiber. This forms a gap that is part of a multi-layered dielectric mirror system. Preferably, the width of the gap is selected not much larger than the wavelength of the laser emission. Since, according to the invention, the distance between the reflecting element of the exit resonator unit and the exit side of the fiber is preferably variable, the thickness of the layer or the width of the gap can be changed. Similar to the entrance resonator unit, the reflectance is changed thereby. Using a specially selected multi-layered dielectric mirror system, a reduction of the reflecting coefficient in the weakest laser transition or an increase of the reflecting coefficient in other laser transitions may occur, for example. In this event, another transition may be excited for laser emission.

Moreover, the entrance and exit resonator units may include still further optical elements such as mirrors, lenses and distances (gaps). The gaps for example between the exit side of the fiber and the first resonator mirror of the exit resonator unit could be filled with a medium other than air to influence the dielectric constant of the gap medium and thereby the reflectance spectrum of the resonator unit.

Preferably, the entrance resonator unit comprises a resonator mirror which, for the laser light to be generated, is highly reflective in the wavelength range with the least light amplification, the mirror especially having a reflection factor from 30% to 100%; a reflection factor of more than 50% is preferred, while a reflection factor of more than 75% is most preferred. Preferably, the exit resonator unit also comprises a resonator mirror which, for the laser light to be generated, is highly reflective in the wavelength range with the least light amplification, the mirror especially having a reflection factor from 30% to 100%; a reflection factor of more than 50% is preferred, while a reflection factor of more than 75% is most preferred. In addition, this resonator mirror can be highly reflective in the wavelength range of the pumped light. For this wavelength range, a reflection factor of more than 50% is preferred, while a factor of more than 80% is particularly preferred.

Preferably, the resonator mirror(s) of the entrance resonator unit is (are) lowly reflective in the wavelength range of the pumped light. It is preferred that the reflection factor is less than 50%, most preferably less than 10%.

The gap or the distance between the reflecting elements of the first resonator unit and the entrance side of the fiber is preferably less than 20 μm, preferably less than 5 μm and, particularly preferred, less than 2 μm. Here, it is particularly preferred to be able to adjust the distance. This may, for example, be done by shifting the reflecting element of the entrance resonator unit and/or the fiber. The wavelength or the wavelength range of the light emission of the fiber laser can be determined through the thickness or width of the gap.

The reflecting element of the exit resonator unit preferably has a distance or gap to the exit side of less than 20 μm, preferably less than 5 μm and, particularly preferred, less than 2 μm. Here, it is particularly preferred to be able to adjust the distance. This may, for example, be done by shifting the reflecting element of the entrance resonator unit and/or the fiber. The wavelength or the wavelength range of the light emission of the fiber laser can be determined through the thickness or width of the gap.

Preferably, at least one of both gaps can be controlled such that the emitted laser light can simultaneously or individually be generated in at least two wavelength ranges. Further, by shifting individual mirrors and/or by changing the medium in the gap, it is possible to adjust the ratio of the light powers of the emitted laser light in at least two wavelength ranges. It is particularly preferred to change both in a controlled manner such that the emitted laser light can simultaneously or individually be generated in at least two wavelength ranges, their light powers preferably also being adjustable.

In a preferred embodiment of the invention, the exit resonator unit comprises an in-coupling optic and a second mirror with corresponding distances. This allows the light emission of the laser to be coupled into a passive optical fiber. The light may then be guided further through the passive optical fiber to an application site. The optical input coupler unit, e.g. a lens, focuses the light exiting from the exit side onto the second mirror of the exit resonator unit, which is situated on the entrance side of the passive optical fiber. Here, it is possible to control the emission spectrum by shifting the optical input coupler unit with chromatic aberration and/or the second mirror.

The second mirror of the exit resonator unit may also be applied directly on the entrance side of a passive optical fiber. In this instance, it is possible to make the exit resonator unit consist of only one, in particular exclusively the second mirror of the exit resonator unit. The gap between this resonator mirror and the exit side of the active fiber is again less than 20 μm, preferably less than 5 μm and, particularly preferred, less than 2 μm.

The resonator mirrors may preferably be multi-layered dielectric mirrors. A possible structure of dielectric layers is described in WO 01/99243 A1 with reference to FIGS. 3a and 3b thereof. The entrance side and/or the exit side of the active fiber may additionally be coated with one or a plurality of dielectric layers.

Shifting individual components of the present fiber laser, in particular the optical elements such as mirror, lens or fiber, is preferably effected piezo-electrically and/or electromagnetically. Moreover, it is possible to effect the shifting by mechanical actuators. Of course, these ways of shifting may also be combined.

The emission power of the fiber lasers can be controlled and regulated using a signal derived from the intensity of the emission power. The regulation is effected by controlling the power of the pumped light source and/or the position of one or more optical elements, i.e. the mirrors and/or the input coupler unit. It is possible in particular to derive different regulating signals, especially for individual optical elements, from the wavelength ranges emitted simultaneously.

Preferred embodiments of the invention are the subject of the dependent claims.

The following is a detailed description of the preferred embodiments of the invention with reference to the accompanying drawings.

In the Figures:

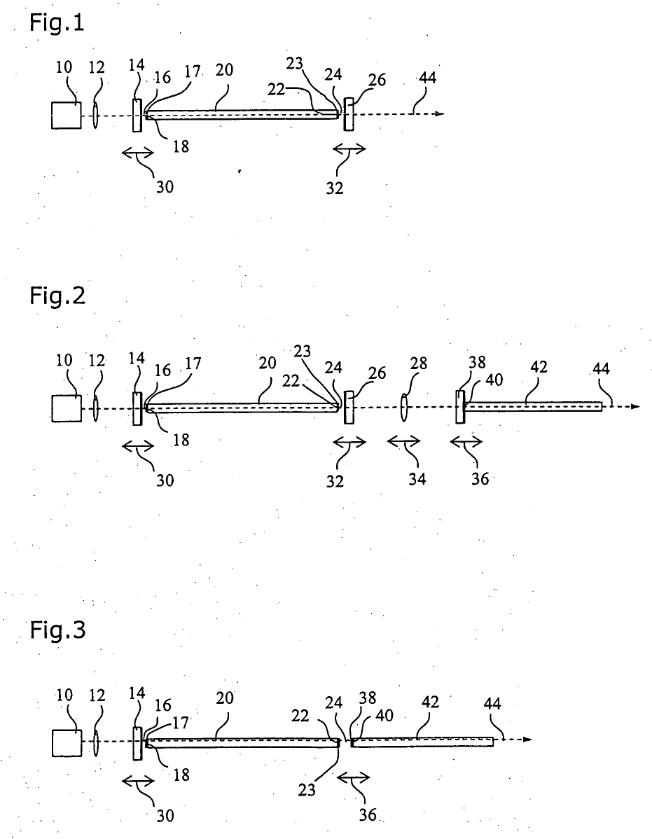

FIG. 1 is a schematic illustration of the general structure of a first preferred embodiment of the fiber laser,

FIG. 2 is a schematic illustration of the general structure of a second preferred embodiment of the fiber laser with its light emission being coupled into a passive optical fiber,

FIG. 3 is a schematic illustration of the general structure of a third preferred embodiment of the fiber laser with its light emission being coupled directly into the passive optical fiber, and

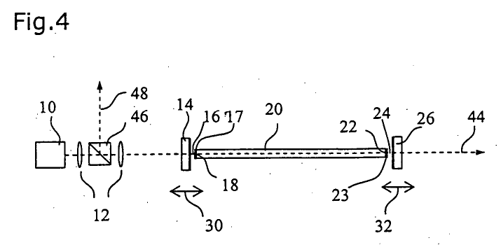

FIG. 4 a schematic illustration of the general structure of a fourth preferred embodiment of the fiber laser with the light emission of the fiber laser being coupled out from the entrance side.

The resonator units, provided at the entrance side 18 and/or at the exit side 22 of the active fiber 20, both consist of only one resonator mirror 14, 26, for example. The first resonator mirror 14 has a controllable distance (gap) 16 from the entrance side 18 of the fiber and/or, on the exit side 22, the second resonator unit 26 also has a controllable distance (gap) 24 from the exit side of the fiber. The gaps are up t0 20 μm thick, adjustable and variable. Preferably, for the laser light to be generated, the first resonator mirror 14 and the second resonator mirror 26 are highly reflective in the wavelength range with the least light amplification and, in particular, have a reflection factor of 30%-100%. In addition, the entrance side 18 and/or the exit side 22 of the active fiber 20 may also be directly coated with dielectric layers.

In a preset state (e.g. both distances set to zero), optimum conditions are achieved for an excitation of the laser emission in the wavelength range with the least light amplification. With a ZBLAN fiber doted with praseodymium and ytterbium, this may be the range at 491 nm, for example. By shifting 30 the first resonator mirror 14 and/or the entrance side of the fiber 18, the width of the gap 16 is varied. The gap 16 (e.g. an air gap) between the mirror 14 and the fiber end face 18 is a part of the multi-layered dielectric mirror system bounded by on one side by the fiber and, on the other side, by the mirror substrate. Varying the thickness of at least one of the dielectric layers including the gap causes a change in the resulting reflecting coefficient. For example, a greater reflection of light can be generated at the wavelength of one of the stronger laser transitions. With a ZBLAN fiber doted with praseodymium and ytterbium, this may be the transition at 635 nm, for example. As a result, the light emission will switch from one color (e.g. 491 nm) to the other color (e.g. 635 nm) when the gap is varied. Since the reflectance of the mirror on the entrance side of the fiber increases, this means that the efficiency also increases, because the light flux now increases in the out-coupling direction. It may also happen that upon a variation of the gap width a few further colors (e.g. 605 nm) may be excited. In the range of the change of color it is also possible to generate at least two colors simultaneously and to adjust the ratio between the light powers in these wavelength ranges.

The gap width 24 is varied by shifting 32 the second resonator mirror and/or the exit side of the fiber. Similar to the first resonator mirror, the reflectance of the second resonator unit changes thereby. With a specially selected multi-layered dielectric mirror system, a reduction of the reflecting coefficient at the weakest laser transition or an increase in the reflecting coefficient at other laser transitions can occur, for example. In this instance, it is possible to excite another transition. With a ZBLAN fiber doted with praseodymium and ytterbium, this may be one of the transitions with emission at 520, 535, 605, 635, 717 and 1300 nm, for example.

A controlled variation 30, 32 of one or both gaps 16, 24 offers the possibility to generate at least three colors at the same time and to adjust the ratio of the light powers in these wavelength ranges. The controlled variation of the two gaps may be effected piezo-electrically, electromagnetically or using a mechanical actuator.

Adding a further mirror 38 (FIG. 2) and an input coupler unit 28 to the second resonator unit with corresponding distances, allows for the light emission of the laser to be coupled directly into a passive optical fiber 42 and to guide this light further to the application site 44 using the passive fiber 42. The optical input coupler unit 28 focuses the light exiting from the exit side 22 onto the second mirror 38 of the second resonator unit situated on the entrance side of the passive optical fiber 42. Here, it is possible to control the emission spectrum by shifting 34 the optical input coupler unit 28 with chromatic aberration and/or the second mirror 38 of the second resonator unit.

The second mirror 38 of the second resonator unit, which is applied directly on the entrance side 40 of a passive optical fiber 42, may also be provided directly at the exit side 22 of the active fiber 22 with a gap 24 of up to 20 μm (FIG. 3), so as to replace the mirror 26 of the second resonator unit.

The exit side 22 and/or the entrance side 18 of the active fiber 20 may additionally be coated 17, 23 directly with one or a plurality of dielectric layers.

The light emission of the fiber laser in one or a plurality of wavelength ranges may also be coupled out 48 from the entrance side 18 of the fiber using a suitable optical coupler unit 12, e.g. a beam splitter 46 (FIG. 4).

The emission power of the fiber lasers can be controlled and regulated using a regulating signal derived from the intensity of the emission power. The emission power for the generation of the regulating signal may be made available by deflecting a part of the output beam 44 or 48 or by using an unused output 44 or 48. The regulation is effected by controlling the power of the pumped light source 10 and/or the position of one or more optical elements, i.e. the mirrors 14, 26, 38 and/or the input coupler unit 28.

With a plurality of simultaneously emitted wavelengths in different spectral ranges, different regulating signals are generated. The different regulating signals may be derived in different ways:
1. By spatial separation of the emitted wavelengths, e.g. using a prism.
2. By spectral separation of the emitted wavelengths, e.g. using color filters.
3. By separating the signals of different polarizations.
4. By separating the noise frequencies of the emitted wavelengths.

In a solid state laser, the maximum of the laser noise is at the frequency of the relaxation oscillation. Since the resonator losses differ in the different wavelength ranges, the frequencies of the relaxation oscillations also differ for different emitted wavelengths. This allows for a separation of the regulating signals using an electronic band pass filter.

Introducing a current regulation that reacts without a perceptible delay and modulates the diode laser current in proportion to the negative of the derivation of the laser output power causes an almost complete suppression of the noise at the frequencies of the relaxation oscillations. Introducing a current regulation of the pumping laser diode in proportion to the deviation of the laser output power from a set value and from the integral of this deviation reduces long-term power variations. An additional temperature stabilization of the regulation may be necessary.

### EMBODIMENT

The present fiber laser comprises a pumping source 10 which preferably is a laser diode. The light emitted by the pumping source is coupled into the active fiber 20 via the entrance side 18 through a collimation unit 12. A first resonator mirror 14 is provided in front of the entrance side, arranged at a distance (gap) 16 from the entrance side 18 of the fiber. In the exit side 22, the second resonator mirror 26 is provided which is also arranged at a distance (gap) 24 from the exit side 22 of the fiber. Both distances can be regulated or adjusted. The mirrors 14, 26 and/or the fiber end faces 18, 22 are shifted 30, 32 or adjusted piezo-electrically, electromechanically or by means of a mechanical actuator.

The pumped laser light coupled into the fiber 20 excites the doping of praseodymium and ytterbium provided in the fiber 20, so that these guarantee light amplification in the desired wavelength ranges. With sufficient light amplification, the resonator losses are compensated and laser emission is generated.

The emission spectrum is controlled by a spectral change in the resonator losses. The resonator losses are determined in particular by the reflection of the resonator mirrors. The mirrors 14, 26 are composed of multi-layered dielectric layer systems vapor deposited on a mirror substrate and/or on the fiber. The gaps 16, 24 between the mirrors 14, 26 and the fiber end faces 18, 22 are parts of the multi-layered dielectric mirror systems bounded on the one side by the fiber and, on the other side, by the mirror substrates. The variation of the thickness of one of these layers, especially of the gaps, causes a change in the resulting reflecting coefficient.

In a preset state, the two gaps are set to zero, for example. Here, optimum conditions must be achieved for an excitation of the implemented laser emission in the wavelength range with the least light amplification. With a ZBLAN fiber doted with praseodymium and ytterbium, this may be the range at 491 nm, for example.

In this case, the total reflecting coefficient of the resonator unit on the entrance side 14, 16, 17, 18 is very high at the wavelength of 491 nm, preferably higher than 90%, most preferably higher than 98%. Contrary to this, the reflection at the wavelength of one of the stronger laser transitions, e.g. at 635 nm, must be low, preferably less than 30%, most preferably less than 2%. The reflecting coefficient at a wavelength of 520 nm must have values from the range between 40% and 99%.

The total reflecting coefficient of the resonator unit on the exit side 22, 23, 24, 26 must preferably have values from the range between 700% and 99% at a wavelength of 491 nm. The reflecting coefficient at a wavelength of 635 nm must preferably have values from the range between 0% to 10%. The reflecting coefficient at a wavelength of 520 nm must preferably have values from the range between 1% to 80%.

The displacements 30, 32 of the resonator mirrors that cause distances will modify the total reflecting coefficient as follows: the displacement 30 of the first resonator mirror 14 results in a higher reflecting coefficient at the wavelength 635 nm; values from the range between 1% and 30% are particularly preferred. However, the reflecting coefficient at the wavelengths of 491 nm and 520 nm preferably remains unchanged. The displacement 32 of the second resonator mirror 26 results in a preferably unchanged reflecting coefficient at a wavelength of 635 nm, yet causes a decreasing reflecting coefficient at a wavelength of 491 nm (preferably 50% to 80%) and/or an increasing reflecting coefficient at a wavelength of 520 nm (preferably 30% to 80%).

The increase in the gap width 16 between the first resonator mirror 14 and the entrance side of the fiber 18 from 0 to 160 nm, for example, results in a reduction of the resonator losses at a wavelength of 635 nm and in a switching of the light emission to this wavelength range. Increasing the gap width 24 between the second resonator mirror 26 and the exit side of the fiber 22 from 0 to 130 nm, for example, results in a reduction of the resonator losses at a wavelength of 520 nm and in a switching of the light mission to this wavelength range. Thus, it is possible to generate laser light in at least three wavelength ranges. In the range of the change of color it is also possible to generate at least three colors at the same time and to adjust the ratio of the light powers in these wavelength ranges.

The multi-layered dielectric layers of the resonator unit on the entrance side 14, 16, 17, 18 and/or on the exit side 22, 23, 24, 26 may comprise two or more partial systems, one partial system 17 or 23 being applied directly at the entrance 18 or the exit side 22 of the fiber, while the other is applied on a mirror substrate 14, 16.

What is claimed is:

1. A fiber laser comprising: a fiber for generating laser light having an entrance side and an exit side,
a pumped light source for generating pumped light adapted to be coupled into the fiber through the entrance side, and
resonator units provided at the entrance side and/or at the exit side of the fiber for feeding the light, at least one wavelength range, exiting at the entrance and/or the exit side back into the fiber,
wherein said entrance resonator unit and/or the exit resonator unit comprise at least one dielectric layer of variable optical thickness to set the at least one emission range.

2. The fiber laser of claim 1, wherein the entrance resonator unit and/or the exit resonator unit comprise a displaceable optical reflecting element to vary the optical thickness of the dielectric layer.

3. The fiber laser of claim 2, wherein the optical reflecting element of the entrance resonator unit and/or the exit resonator unit is arranged at a variable distance from the entrance side or the exit side, respectively.

4. The fiber laser of claim 1, wherein the entrance resonator unit and/or the exit resonator unit comprise a pressure variable gaseous medium to vary the optical thickness of the dielectric layer.

5. The fiber laser of claim 1, wherein, in the entrance resonator unit and/or the exit resonator unit, the dielectric layer is arranged in a variable electric field to vary the optical thickness of the dielectric layer.

6. The fiber laser of claim 1, wherein the entrance resonator unit and/or the exit resonator unit are, for the laser light to be generated, highly reflective in the wavelength range with the least light amplification, having a reflection factor from 30% to 100%.

7. The fiber laser of claim 1, wherein the entrance resonator unit has a low reflection factor, especially below 50%, particularly preferred below 10%, for the wavelength range of the pumped light.

8. The fiber laser of claim 1, wherein, between the reflecting element of the resonator unit and the entrance side of the fiber and/or between the reflective element of the exit resonator unit and the exit side of the fiber, a gap with a width of up to 20 μm is provided which is adjustable and controllable and through the width of which the wavelength of the light emission of the fiber laser may be determined.

9. The fiber laser of claim 1, wherein the gap may be controlled such that laser light is generated simultaneously or individually in at least two wavelength ranges.

10. The fiber laser of claim 1, wherein the exit resonator unit comprises two mirrors, the first mirror being highly reflective for the laser light to be generated in the wavelength range with the least light amplification, having a reflection factor from 30%-100%, and the second mirror is suitable for feeding light exiting at the exit side, at least one wavelength range, back into the fiber.

11. The fiber laser of claim 10, wherein the second mirror of the exit resonator unit is highly reflective at least for the other wavelength range for which the first mirror of the exit resonator unit is substantially transparent so that laser light is generated in this other wavelength range.

12. The fiber laser of claim 10, wherein the exit resonator unit comprises an optical coupler unit focusing the light exiting from the exit side on the second resonator mirror.

13. The fiber laser of claim 12, wherein the optical coupler unit is configured such that it serves to control the emission spectrum.

14. The fiber laser of claim 12, wherein the optical coupler unit is an aspheric lens with chromatic aberration.

15. The fiber laser of claim 12, wherein the optical coupler unit is adapted to be displaced for the control of the emission spectrum.

16. The fiber laser of claim 12, wherein the second mirror of the exit resonator unit is adapted to be displaced for the control of the emission spectrum.

17. The fiber laser of claim 10, wherein the second mirror of the exit resonator unit is connected with an entrance side of a passive optical fiber.

18. The fiber laser of claims 1, wherein the exit resonator unit comprises only one mirror which is directly connected with the entrance side of a passive optical fiber and forms a gap with the exit side that is up to 20 μm wide.

19. The fiber laser of claims 1, wherein the entrance side and/or the exit side of the active fiber is coated with one or a plurality of dielectric layers.

20. The fiber laser of claim 1, wherein the mirrors are multi-layered dielectric mirrors.

21. The fiber laser of claim 1, wherein single-layered and multi-layered dielectric systems are arranged at the entrance side and/or the exit side.

22. The fiber laser of claim 1, wherein the displacement or the adjustment of an optical element and/or a plurality of optical elements, mirrors and/or the input coupler unit is effected piezo-electrically and/or electromagnetically and/or by a mechanical actuator.

23. A method for operating a fiber laser comprising: a fiber for generating laser light having an entrance side and an exit side, a pumped light source for generating pumped light adapted to be coupled into the fiber through the entrance side, and resonator units provided at the entrance side and/or at the exit side of the fiber for feeding the light, at least one wavelength range, exiting at the entrance and/or the exit side back into the fiber, wherein said entrance resonator unit and/or the exit resonator unit comprise at least one dielectric layer of variable optical thickness to set the at least one emission range, wherein a regulating signal is generated from the intensity of the emission power, which adjusts and/or regulates the emission power of the fiber laser by driving the power of the pumping light source and/or the position of one or a plurality of optical elements among the mirrors and the input coupler unit.

24. The method of claim 23, wherein different regulating signals are generated from the intensity of the simultaneously emitted wavelength ranges.

25. The method of claim 24, wherein the different regulating signals are generated by a spatial and/or spectral separation and/or a separation of the polarization signals and/or of the noise frequencies of the emitted wavelength ranges.

26. The method of claim 23, wherein different regulating signals are generated from the intensity of the emission power, which adjust and/or regulate the distribution of the emission power in different wavelength ranges of the fiber laser by driving the power of the pumping light source and/or the position of one or a plurality of optical elements among the mirrors and the input coupler unit.

27. The method of claim 23, wherein the light emission of the fiber laser in one or a plurality of wavelength ranges is coupled out from the entrance side of the fiber using a suitable optical coupler unit.
